(19) United States
(12) Patent Application Publication
(10) Pub. No.: US 2026/0071663 A1
(43) Pub. Date: Mar. 12, 2026

(54) FRICTION PAIR

(71) Applicant: NISSHINBO BRAKE INC., TOKYO (JP)

(72) Inventors: Sota FUNAMOTO, GUNMA-KEN (JP); Kenta KURIMOTO, GUNMA-KEN (JP)

(73) Assignee: NISSHINBO BRAKE INC., TOKYO (JP)

(21) Appl. No.: 19/390,685

(22) Filed: Nov. 17, 2025

Related U.S. Application Data
(63) Continuation-in-part of application No. 18/008,444.

(30) Foreign Application Priority Data
Jun. 16, 2020 (JP) 2020-103802

(51) Int. Cl. F16D 69/02; F16D 65/092; F16D 65/12

(52) U.S. Cl. CPC F16D 69/026; F16D 65/092; F16D 65/125; F16D 65/127; F16D 2200/0021; F16D 2200/0065; F16D 2250/0023; F16D 2250/0046

(57) ABSTRACT

To provide a friction pair having an excellent stability of a braking effect and wear resistance of a friction material, where the friction pair is consisting of a disc brake pad having a friction material manufactured from a friction material composition containing a binder, a fiber base material, and a friction modifier, but not containing a copper component and a ferrous-base metallic fiber, and a stainless steel disc rotor. The present invention uses a friction material composition that does not contain a metallic fiber other than a ferrous-base metallic fiber but contains 10-15 wt % of a carbonaceous lubricant as a friction modifier relative to an entire friction material composition, and 15-30 wt % of an inorganic friction modifier with Mohs hardness of 6 or more relative to the entire friction material composition, where a thermal conductivity of the friction material is 1.2-3.0W/m·K.

### CROSS-REFERENCE TO RELATED APPLICATIONS

This application is a Continuation-in-Part of U.S. patent application Ser. No. 18/008,444, filed on Dec. 5, 2022, which is a national stage application under 35 U.S.C. § 371 of International Patent Application No. PCT/JP2021/021877, filed on Jun. 9, 2021, which claims priority to Japanese Patent Application No. 2020-103802, filed on Jun. 16, 2020. The entire disclosures of the above applications are incorporated herein by reference in their entireties.

### BACKGROUND OF THE INVENTION

### Field of Invention

The present invention relates to a friction pair, and more particularly to a friction pair for use in vehicles such as passenger cars.

### Description of the Related Arts

Conventionally, disc brake pads having a friction material affixed to a metal backing plate have been widely used as friction members in disc brakes for passenger cars.

In recent years, as demands for quieter braking have increased, disc brake pads employing non-asbestos organic (NAO) friction materials, which generate less brake noise, have come into widespread use.

NAO friction materials are manufactured from a friction material composition including a binder and a fiber base material other than steel-based fibers, such as steel fibers or stainless steel fibers. NAO friction materials are classified as one type of friction material alongside semi-metallic friction materials and low-steel friction materials, which do include steel-based fibers as the fiber base material. More recently, due to regulations in the United States restricting the amount of copper permitted in friction materials, compositions containing 5 wt % or less of copper, or no copper at all, have become increasingly common.

Patent Document 1 (Japanese Provisional Patent Publication No. 2017-57312) discloses a friction material composition containing a fiber base material, a friction modifier, and a binder. The composition includes a copper component of 0.5 wt % or less, based on the copper element, and further contains a granular titanate obtained by granulating titanate. The granular titanate has an average particle diameter of 100-250 μm. Patent Document 1 also discloses a friction material formed from such a composition.

Patent Document 2 (Japanese Provisional Patent Publication No. 2018-162385) discloses a friction material composition containing a fiber base material, an inorganic filler, an organic filler, and a binder. The composition includes 0.5 wt % or less of copper. As part of the inorganic filler, the composition further contains abrasives having average particle diameters of 3-5 μm and 9-13 μm. In addition, as another part of the inorganic filler, the composition contains titanates having average particle diameters of 1.5-4.5 μm and 15-45 μm.

As a mating member for disc brake pads using such friction materials containing little or no copper, cast iron disc rotors, as disclosed in Patent Document 3 (Japanese Provisional Patent Publication No. 1990-134425), have been employed. However, cast iron disc rotors exhibit low corrosion resistance and tend to rust during use, creating the need for countermeasures in the friction material to address this problem.

For example, Patent Document 4 (Japanese Provisional Patent Publication No. 2017-149971) discloses a friction material containing a binder, a friction modifier, and a fiber base material. The material improves the descaling performance of the mating member by including no copper component, 10-20 volume % of at least one type of titanate compound having multiple projections, and 1-20 volume % of a biosoluble inorganic fiber, each relative to the total amount of the friction material composition.

However, with the adoption of regenerative braking in electric and hybrid vehicles, the load applied to the friction material by conventional hydraulic braking is reduced. As a result, even the technology disclosed in Patent Document 4 does not provide sufficient descaling performance.

Accordingly, stainless steel disc rotors, which offer superior rust resistance, have come into common use.

Patent Document 5 (Japanese Provisional Patent Publication No. 2016-117925) discloses a disc rotor for a four-wheel vehicle manufactured from a stainless steel plate. The rotor has either a martensitic structure or a mixed structure of martensitic and ferritic phases.

Patent Document 6 (Japanese Provisional Patent Publication No. 2019-173086) discloses a disc rotor for an automobile having a structure that contains martensite and carbonitride, and selectively contains ferrite.

Patent Document 7 (Japanese Provisional Patent Publication No. 2019-178419) discloses the disc rotor for an automobile made of the stainless steel plate that includes C: 0.005-0.100%, Si: 0.01-1.00%, Mn: 0.010-3.00%, P: 0.040% or less, S: 0.0100% or less, Cr: 10.0-14.0%, N: 0.005-0.100%, V: 0.03-0.30%, Al: 0.001-0.050%, B: 0.0002-0.0050%, Ni: 0-2.00%, Cu: 0-2.00%, Mo: 0-1.00%, W: 0-1.00%, Ti: 0-0.40%, Nb: 0-0.40%, Zr: 0-0.40%, Co: 0-0.400%, Sn: 0-0.40%, REM: 0-0.050% or less, Mg: 0-0.0100%, Ca: 0-0.0100%, Sb: 0-0.50%, Ta: 0-0.3000%, Hf: 0-0.3000%, and Ga: 0-0.1000%, and the remaining substances are Fe and impurities, where a metal structure is made of a ferrite phase and 10-50 particles per 100 μm2 of carbonitride with 0.3 μm or more of equivalent circle diameter exists at an arbitrary cross section thereof.

In view of the above-described background, there has been demand for a friction material that contains no copper component and is suitable for use with stainless steel disc rotors having superior rust resistance. However, it was found that applying the conventional friction material that does not contain the copper component and is used in combination with the cast iron disc rotor to the disc brake employing the stainless steel disc rotor would significantly reduce a stability of the braking effect in the low speed range.

### SUMMARY OF THE INVENTION

The present invention is directed to providing a friction pair that exhibits excellent braking stability and superior wear resistance of the friction material. The friction pair includes a stainless steel disc rotor and a disc brake pad formed from a friction material composition comprising a binder, a fiber base material, and a friction modifier, while being entirely free of copper components and metallic fibers, including ferrous-based metallic fibers.

The inventors, after extensive investigation, discovered that a friction pair including a stainless steel disc rotor and a disc brake pad manufactured from a friction material composition including a binder, a fiber base material, and a friction modifier but excluding copper components and ferrous-base metallic fibers, achieves excellent braking stability and wear resistance when the composition (i) excludes all metallic fibers including ferrous-based fibers, (ii) contains a predetermined amount of carbonaceous lubricant as a friction modifier, (iii) further contains a predetermined amount of an inorganic friction modifier having a Mohs hardness of 6 or greater, and (iv) is controlled to provide a thermal conductivity within a predetermined range.

This invention relates to a friction pair including a stainless steel disc rotor and a disc brake pad manufactured from a friction material composition that includes a binder, a fiber base material, and a friction modifier, while being entirely free of copper components and free of all metallic fibers, including ferrous-based metallic fibers, and is further based on the following technology.

The friction pair of the present invention includes a stainless steel disc rotor and a disc brake pad having a friction material manufactured from a friction material composition that contains a binder, a fiber base material, and a friction modifier, but excludes copper components and all metallic fibers, including ferrous-based metallic fibers. The friction material composition contains 10-15 wt % of a carbonaceous lubricant as the friction modifier relative to the total weight of the composition, 15-30 wt % of an inorganic friction modifier having a Mohs hardness of 6 or greater relative to the total weight of the composition, and is controlled such that the thermal conductivity of the friction material is within the range of 1.2-3.0 W/m·K.

The above friction pair may use a carbonaceous lubricant formed from one or more materials selected from the group consisting of artificial graphite, natural graphite, graphite sheet pulverized powder, petroleum coke, coal coke, resilient graphite carbon, and polyacrylonitrile oxidized fiber pulverized powder.

The above friction pair may use a carbonaceous lubricant made of the graphite sheet pulverized powder, the petroleum coke, and the resilient graphite carbon.

The above friction pair may further use 13-28 wt % of zirconium oxide having an average particle diameter of 0.5-8.0 μm, relative to the entire friction material composition, as part of the inorganic friction modifier with a Mohs hardness of 6 or more.

This invention relates to a friction pair including a stainless steel disc rotor and a disc brake pad having a friction material manufactured from a friction material composition containing a binder, a fiber base material, and a friction modifier, while excluding copper components and all metallic fibers, including ferrous-based metallic fibers. The invention provides a friction pair that delivers excellent braking stability and superior wear resistance of the friction material.

### EMBODIMENTS FOR CARRYING OUT THE INVENTION

A stainless steel disc rotor exhibits lower thermal conductivity and lower thermal diffusivity compared with a conventional cast iron disc rotor. Stainless steel also has slightly higher specific gravity but greater strength than cast iron. Accordingly, when considering equivalent weight and strength conditions, the stainless steel rotor is typically made thinner than a cast iron rotor. As a result, the heat capacity of the rotor is smaller, leading to greater heat accumulation in the rotor and higher operating temperatures at the friction material interface.

Compared to gray cast iron rotors, which have thermal conductivity of approximately 44-58 W/m·K, martensitic stainless steel rotors exhibit much lower values, approximately 20-25 W/m·K. Because of this difference, heat generated at the pad-rotor interface dissipates less effectively into a stainless steel rotor, causing elevated pad surface temperatures and a greater risk of thermal fade. By contrast, cast iron rotors act as efficient heat sinks that stabilize braking torque. In addition, stainless steel forms chromium-rich oxides at the surface, which alter interfacial friction characteristics, whereas cast iron forms softer iron oxides that contribute to a more stable and self-renewing friction layer. These differences mean that friction materials optimized for cast iron rotors cannot simply be substituted for stainless steel rotors. Stable braking performance requires precise control of the friction material composition, including exclusion of copper and metallic fibers, and maintaining the thermal conductivity of the friction material within the range of 1.2-3.0 W/m·K.

Conventional friction material technologies often tolerate copper levels up to about 0.5 weight percent to comply with environmental regulations such as California Health and Safety Code § 25250.53. While such tolerance may be acceptable with cast iron rotors, even trace copper content promotes galvanic corrosion with stainless steel rotors and destabilizes the protective chromium-rich oxide film. The present invention therefore requires complete exclusion of copper (0.0 weight percent), thereby preventing stainless steel corrosion and eliminating the variability in fade resistance associated with residual copper. Similarly, metallic fibers such as aluminum, brass, or stainless steel, which are sometimes used to reinforce strength or increase thermal conductivity in cast iron applications, are excluded. In stainless steel systems, metallic fibers create localized thermal hotspots, accelerate binder decomposition, and promote corrosion at the pad-rotor interface. For these reasons, the invention excludes all metallic fibers and instead employs carefully balanced amounts of carbonaceous and inorganic friction modifiers.

The inventors determined that thermal conductivity of the friction material must be strictly controlled within 1.2-3.0 W/m·K to ensure compatibility with stainless steel rotors. If the conductivity falls below 1.2 W/m·K, the generated heat cannot dissipate, leading to binder decomposition, glazing of the friction surface, and loss of braking stability. If the conductivity exceeds 3.0 W/m·K, an excessive amount of carbonaceous lubricant imparts a strong lubricating effect, destabilizing the friction coefficient and causing slippage, particularly at low speeds. More preferably, the thermal conductivity is maintained within the narrower range of 1.5-2.8 W/m·K, and most preferably around 2.0 W/m·K, which represents an optimal balance of heat dissipation and braking stability.

When the temperature of the friction material becomes excessively high, organic constituents such as the binder, as well as certain inorganic modifiers, tend to undergo thermal decomposition. As these decomposition products deposit on the friction surface, the stability of the braking effect is reduced. In addition, decomposition of the binder markedly lowers the structural strength of the friction material, thereby significantly reducing its wear resistance.

In view of the above issues, the present invention provides a friction pair including a stainless steel disc rotor and a disc brake pad having a friction material manufactured from a composition that contains a binder, a fiber base material, and a friction modifier, while excluding copper components and all metallic fibers, including ferrous-based metallic fibers. The friction material composition contains 10-15 wt % of a carbonaceous lubricant as a friction modifier relative to the entire composition, 15-30 wt % of an inorganic friction modifier having a Mohs hardness of 6 or greater relative to the entire composition, and is controlled such that the thermal conductivity of the friction material is within the range of 1.2-3.0 W/m·K.

Heat dissipation in the friction material can be achieved by incorporating a relatively large amount of carbonaceous lubricant as a friction modifier relative to the entire amount of the friction material composition, and by controlling the thermal conductivity of the friction material so that it falls within the predetermined range.

In this specification, the friction material portion is taken from the final product, i.e., the disc brake pad, and the thermal conductivity of the portion is measured by the hot-wire method using a Rapid Thermal Conductivity Meter.

By setting the amount of the carbonaceous lubricant and the thermal conductivity of the friction material within the above-stated range, heat dissipation of the friction material is enhanced and the rise in temperature is suppressed. As a result, thermal decomposition of the organic constituents contained in the friction material is inhibited, and the lubricating action of the carbonaceous lubricant contributes to improved wear resistance.

However, merely adding a relatively large amount of carbonaceous lubricant reduces the stability of the braking effect due to its inherent lubricating action. Therefore, in order to counteract this effect, 15-30 wt % of an inorganic friction modifier having a Mohs hardness of 6 or greater, relative to the entire friction material composition, is added as a friction modifier.

By setting the amount of the inorganic friction modifier having a Mohs hardness of 6 or greater within the above-stated range, a grinding effect against the disc rotor is produced, and excellent braking stability can be maintained even when a relatively large amount of carbonaceous lubricant is added.

In this invention, the Mohs hardness refers to the conventional Mohs scale, in which 1 corresponds to talc, 2 to gypsum, 3 to calcite, 4 to fluorite, 5 to apatite, 6 to orthoclase feldspar, 7 to quartz, 8 to topaz, 9 to corundum, and 10 to diamond.

As the carbonaceous lubricant, any one of artificial graphite, natural graphite, graphite sheet pulverized powder, petroleum coke, coal coke, resilient graphite carbon, or polyacrylonitrile oxidized fiber pulverized powder may be used individually, or a combination of two or more of these materials may be employed. Preferably, a combination of graphite sheet pulverized powder, petroleum coke, and resilient graphite carbon is used.

The graphite sheet pulverized powder is obtained by acid-treating and heat-expanding natural graphite, roll-pressing the expanded graphite into a sheet, and then pulverizing the sheet. The resilient graphite carbon is produced by graphitizing a carbon material at 1900-2700° C. and terminating the graphitization process at 80-95% completion.

As the inorganic friction modifier having a Mohs hardness of 6 or greater, any one of triiron tetroxide, magnesium oxide, zirconium oxide, silicon dioxide, zirconium silicate, γ-alumina, α-alumina, silicon carbide, glass fiber, biosoluble ceramic fiber, rock wool, or basalt fiber may be used individually, or a combination of two or more of these materials may be employed.

As part of the inorganic friction modifier having a Mohs hardness of 6 or greater, it is preferable to include zirconium oxide having an average particle diameter of 0.5-8 μm. The total amount of inorganic friction modifier is 15-30 wt % relative to the entire friction material composition, and within this range, the zirconium oxide is preferably included in an amount of 13-28 wt %.

The use of zirconium oxide within the range of 13-28 wt % and having an average particle diameter of 0.5-8 μm is particularly preferred. Particles below 0.5 μm are less effective in providing a grinding action, while particles larger than 8 μm increase uneven wear on the rotor surface. The defined size range ensures a uniform interfacial layer formation and enhances both wear resistance and braking stability.

In this specification, the term “average particle diameter” refers to the 50 D value measured by a Laser Diffraction Particle Size Analyzer.

### <Friction Material Composition>

The friction material used in the friction pair of the present invention is produced from a friction material composition of the general type containing a binder, a fiber base material, and a friction modifier, further including the above-described carbonaceous lubricant and the inorganic friction modifier having a Mohs hardness of 6 or greater.

As the binder, any of the binders generally used for friction materials may be employed, including straight phenol resin, acrylic rubber-modified phenol resin, silicone rubber-modified phenol resin, nitrile rubber (NBR)-modified phenol resin, cashew nut shell liquid (CNSL)-modified phenol resin, aralkyl-modified phenol resin (phenol aralkyl resin) obtained by reacting a phenol compound, an aralkyl ether compound, and an aldehyde compound, acrylic rubber-dispersed phenol resin, silicone rubber-dispersed phenol resin, and fluoropolymer-dispersed phenol resin. A combination of two or more of these binders may also be used.

The amount of binder contained in the friction material composition is preferably 4-9 wt % relative to the total weight of the composition, and more preferably 6-8 wt %.

As the fiber base material, any of the fibers generally used in friction materials may be employed, including aramid fiber, acrylic fiber, cellulose fiber, and poly-phenylene benzbisoxazole fiber. A combination of two or more of these fiber base materials may also be used.

The amount of the fiber base material in the friction material composition is preferably 1-5 wt % relative to the total weight of the composition, and more preferably 2-4 wt %.

As the friction modifier, a lubricant, an inorganic friction modifier, and an organic friction modifier may be employed.

As the lubricant, in addition to the above-described carbon-based lubricants, any of the following metal sulfide lubricants may be used: tin sulfide, molybdenum disulfide, iron sulfide, bismuth sulfide, zinc sulfide, or a composite metal sulfide. A combination of two or more of these lubricants may also be employed.

The total amount of lubricant in the friction material composition, including the above-described carbonaceous lubricant, is preferably 10-18 wt % relative to the total weight of the composition, and more preferably 11-16 wt %.

As the inorganic friction modifier, in addition to the above-described modifiers having a Mohs hardness of 6 or greater, other modifiers may also be employed. Examples include calcium hydroxide, calcium carbonate, barium sulfate, talc, dolomite, zeolite, calcium silicate hydrate, and various titanates such as columnar titanate, plate-like titanate, particulate titanate, scale-shaped titanate, or irregular titanate having multiple projections. The titanate may be, for example, potassium titanate, lithium potassium titanate, magnesium potassium titanate, or sodium titanate. Wollastonite and sepiolite may also be used. A combination of two or more of these inorganic friction modifiers may likewise be employed.

The total amount of inorganic friction modifiers in the friction material composition, including both those having a Mohs hardness of 6 or greater and those having a lower Mohs hardness, is preferably 60-82 wt % relative to the total weight of the composition, and more preferably 65-76 wt %.

As the organic friction modifier, any of the organic modifiers generally used in friction materials may be employed, such as cashew dust, tire tread rubber pulverized powder, polytetrafluoroethylene (PTFE) powder, and vulcanized or unvulcanized rubbers including acrylic rubber, isoprene rubber, nitrile butadiene rubber, styrene-butadiene rubber, butyl rubber, and silicone rubber. A combination of two or more of these organic friction modifiers may also be used.

The amount of organic friction modifier contained in the friction material composition is preferably 3-8 wt % relative to the total weight of the composition, and more preferably 5-7 wt %.

In addition to the friction pair as a product, the invention also encompasses a method for manufacturing a disc brake pad for use in the friction pair. The method includes the steps of: mixing predetermined amounts of the friction material composition to obtain a raw friction material mixture; pre-forming or granulating the mixture if desired; heat-pressing the mixture onto a back plate under predetermined pressure and temperature conditions; curing the pressed article by post-heating; applying a coating and baking; and finally grinding the friction surface. Variations such as kneading steps prior to forming or scorching steps after forming may also be applied.

### <Manufacturing Method for Disc Brake Pad>

The disc brake pad according to this invention may be manufactured by the following process. First, a mixing step is performed in which predetermined amounts of the friction material composition (raw friction material) are uniformly mixed in a mixer to obtain a raw friction material mixture. Next, in a heat press forming step, the raw friction material mixture is placed on a pre-washed, surface-treated, and adhesive-coated back plate, positioned in a heat-forming die, and heat-pressed onto the back plate to obtain a heat-pressed article. In a subsequent heating step, the heat-pressed article is subjected to heating to cause a curing reaction and thereby obtain a cured article. A coating step then follows, in which the cured article is coated—for example, by spray coating or electrostatic powder coating—after which a baking step is performed to bake the coating and obtain a baked article. Finally, a grinding step is carried out in which the baked article is ground by a rotary grinder to form the friction surface.

The specified content ranges for each component of the friction material composition are critical to achieving the balance required for stainless steel rotor applications. Binder content below 4 wt % results in insufficient structural strength, while amounts above 9 wt % reduce thermal stability. Fiber base material below 1 wt % fails to provide reinforcement, while amounts above 5 wt % increase chance of mixing defects. Similarly, when the content of the organic friction modifier is less than 3 wt %, sufficient NV performance cannot be obtained, whereas when it exceeds 8 wt %, the braking coefficient becomes unstable. These compositional ranges, in combination with the absolute exclusion of copper and metallic fibers and the defined thermal conductivity range, are indispensable for achieving consistent braking stability, wear resistance, and product appearance.

Further, after the heat press forming step, a heat treatment process may be carried out, which includes the coating step followed by the baking step, and thereafter the grinding step may be performed.

In addition, as appropriate, one or more preliminary steps may be conducted prior to the heat press forming step. These may include a granulating step for granulating the raw friction material mixture, a kneading step for kneading the raw friction material mixture, and a pre-forming step for producing a pre-formed article by positioning the raw friction material mixture, the granulated article, or the kneaded article. After the heat press forming step, a scorching step may also be performed.

### <Stainless Steel Disc Rotor>

As the stainless steel disc rotor, a martensitic stainless steel rotor or a ferritic stainless steel rotor may be used. Martensitic stainless steel rotors are preferred for their high strength and wear resistance, whereas ferritic stainless steel rotors are advantageous for corrosion resistance. The invention is applicable to either structure, thereby ensuring broad industrial applicability.

### Embodiments

The present invention will now be described more concretely with reference to the following Embodiments and Comparative Examples. However, the invention is not limited to these examples.

### [Manufacturing Method for the Friction Material According to Embodiments 1-14 and Comparative Examples 1-5]

Friction material compositions having the formulations shown in Table 1 and Table 2 were mixed in a Loedige mixer for about five minutes, then pressed in a pre-forming die at 30 MPa for about ten seconds to obtain a pre-formed article. The pre-formed article was placed on a pre-washed, surface-treated, and adhesive-coated steel back plate, and heat-pressed in a forming die at 150° C. under a pressure of 40 MPa for about ten minutes. Thereafter, a heat treatment (post-cure) was carried out at 200° C. for about five hours. Finally, the grinding step was performed to form the friction surface, thereby producing a disc brake pad for a passenger car.

TABLE 1

| | | | | embodiments | | | | | | | | |
|---|---|---|---|---|---|---|---|---|---|---|---|---|
| | | | | 1 | 2 | 3 | 4 | 5 | 6 | 7 | 8 | 9 |
| binder | | | straight phenol resin | 7.0 | 7.0 | 7.0 | 7.0 | 7.0 | 7.0 | 7.0 | 7.0 | 7.0 |
| fiber base | | | aramid fiber | 2.5 | 2.5 | 2.5 | 2.5 | 2.5 | 2.5 | 2.5 | 2.5 | 2.5 |
| friction | lubricant | carbonaceous | graphite sheet | 4.5 | 4.5 | 5.0 | 6.0 | 7.0 | 5.0 | 5.0 | 5.0 | 5.0 |
| modifier | | lubricants | pulverized powder | | | | | | | | | |
| | | | petroleum coke | 4.5 | 4.5 | 5.0 | 6.0 | 7.0 | 5.0 | 5.0 | 5.0 | 5.0 |
| | | | resilient graphite | | 1.0 | 1.0 | 1.0 | 1.0 | 1.0 | 1.0 | 1.0 | 1.0 |
| | | | carbon | | | | | | | | | |
| | | | natural graphite | 1.0 | | | | | | | | |
| | | | (scale shape graphite) | | | | | | | | | |
| | | metal sulfide | zinc sulfide | 1.0 | 1.0 | 1.0 | 1.0 | 1.0 | 1.0 | 1.0 | 1.0 | 1.0 |
| | | lubricants | | | | | | | | | | |

| inorganic friction | zirconium oxide: average | | | | | | | | | |
|---|---|---|---|---|---|---|---|---|---|---|
| modifier | particle diameter of 0.3 μm | | | | | | | | | |
| | zirconium oxide: average | | | | | | | | | |
| | particle diameter of 0.5 μm | | | | | | | | | |
| | zirconium oxide: average | 23.0 | 23.0 | 23.0 | 23.0 | 23.0 | 13.0 | 20.0 | 25.0 | 28.0 |
| | particle diameter of 3.0 μm | | | | | | | | | |
| | zirconium oxide: average | | | | | | | | | |
| | particle diameter of 5.0 μm | | | | | | | | | |
| | zirconium oxide: average | | | | | | | | | |
| | particle diameter of 8.0 μm | | | | | | | | | |
| | zirconium oxide: average | | | | | | | | | |
| | particle diameter of 10.0 μm | | | | | | | | | |
| | zirconium silicate | 1.0 | 1.0 | 1.0 | 1.0 | 1.0 | 1.0 | 1.0 | 1.0 | 1.0 |
| | Γ alumina | 1.0 | 1.0 | 1.0 | 1.0 | 1.0 | 1.0 | 1.0 | 1.0 | 1.0 |
| | potassium titanate | 20.0 | 20.0 | 20.0 | 20.0 | 20.0 | 20.0 | 20.0 | 20.0 | 20.0 |
| | calcium hydroxide | 3.0 | 3.0 | 3.0 | 3.0 | 3.0 | 3.0 | 3.0 | 3.0 | 3.0 |
| | barium sulfate | 25.0 | 25.0 | 24.0 | 22.0 | 20.0 | 34.0 | 27.0 | 22.0 | 19.0 |
| organic friction | cashew dust | 5.0 | 5.0 | 5.0 | 5.0 | 5.0 | 5.0 | 5.0 | 5.0 | 5.0 |
| modifier | tire tread rubber | 1.5 | 1.5 | 1.5 | 1.5 | 1.5 | 1.5 | 1.5 | 1.5 | 1.5 |
| | pulverized powder | | | | | | | | | |

| total | | 100.0 | 100.0 | 100.0 | 100.0 | 100.0 | 100.0 | 100.0 | 100.0 | 100.0 |
|---|---|---|---|---|---|---|---|---|---|---|
| | thermal conductivity | 1.5 | 1.2 | 1.8 | 2.3 | 2.9 | 1.8 | 1.6 | 1.6 | 1.4 |
| | (W/m · K) | | | | | | | | | |

TABLE 2

| | | | | embodiments | | | | | comparative examples | | | | |
|---|---|---|---|---|---|---|---|---|---|---|---|---|---|
| | | | | 10 | 11 | 12 | 13 | 14 | 1 | 2 | 3 | 4 | 5 |
| binder | | | straight phenol resin | 7.0 | 7.0 | 7.0 | 7.0 | 7.0 | 7.0 | 7.0 | 7.0 | 7.0 | 7.0 |
| fiber base | | | aramid fiber | 2.5 | 2.5 | 2.5 | 2.5 | 2.5 | 2.5 | 2.5 | 2.5 | 2.5 | 2.5 |
| friction | lubricant | carbonaceous | graphite sheet | 5.0 | 5.0 | 5.0 | 5.0 | 5.0 | 4.0 | 1.0 | 7.5 | 5.0 | 5.0 |
| modifier | | lubricants | pulverized powder | | | | | | | | | | |
| | | | petroleum coke | 5.0 | 5.0 | 5.0 | 5.0 | 5.0 | 4.0 | 1.0 | 7.5 | 5.0 | 5.0 |
| | | | resilient graphite carbon | 1.0 | 1.0 | 1.0 | 1.0 | 1.0 | 1.0 | 1.0 | 1.0 | 1.0 | 1.0 |
| | | | natural graphite | | | | | | | 7.0 | | | |
| | | | (scale shape graphite) | | | | | | | | | | |
| | | metal sulfide | zinc sulfide | 1.0 | 1.0 | 1.0 | 1.0 | 1.0 | 1.0 | 1.0 | 1.0 | 1.0 | 1.0 |
| | | lubricants | | | | | | | | | | | |

| inorganic friction | zirconium oxide: average | 23.0 | | | | | | | | | |
|---|---|---|---|---|---|---|---|---|---|---|---|
| modifier | particle diameter of 0.3 μm | | | | | | | | | | |
| | zirconium oxide: average | | 23.0 | | | | | | | | |
| | particle diameter of 0.5 μm | | | | | | | | | | |
| | zirconium oxide: average | | | | | | 23.0 | 23.0 | 23.0 | 12.0 | 29.0 |
| | particle diameter of 3.0 μm | | | | | | | | | | |
| | zirconium oxide: average | | | 23.0 | | | | | | | |
| | particle diameter of 5.0 μm | | | | | | | | | | |
| | zirconium oxide: average | | | | 23.0 | | | | | | |
| | particle diameter of 8.0 μm | | | | | | | | | | |
| | zirconium oxide: average | | | | | 23.0 | | | | | |
| | particle diameter of 10.0 μm | | | | | | | | | | |
| | zirconium silicate | 1.0 | 1.0 | 1.0 | 1.0 | 1.0 | 1.0 | 1.0 | 1.0 | 1.0 | 1.0 |
| | Γ alumina | 1.0 | 1.0 | 1.0 | 1.0 | 1.0 | 1.0 | 1.0 | 1.0 | 1.0 | 1.0 |
| | potassium titanate | 20.0 | 20.0 | 20.0 | 20.0 | 20.0 | 20.0 | 20.0 | 20.0 | 20.0 | 20.0 |
| | calcium hydroxide | 3.0 | 3.0 | 3.0 | 3.0 | 3.0 | 3.0 | 3.0 | 3.0 | 3.0 | 3.0 |
| | barium sulfate | 24.0 | 24.0 | 24.0 | 24.0 | 24.0 | 26.0 | 25.0 | 19.0 | 35.0 | 18.0 |
| organic friction | cashew dust | 5.0 | 5.0 | 5.0 | 5.0 | 5.0 | 5.0 | 5.0 | 5.0 | 5.0 | 5.0 |
| modifier | tire tread rubber | 1.5 | 1.5 | 1.5 | 1.5 | 1.5 | 1.5 | 1.5 | 1.5 | 1.5 | 1.5 |
| | pulverized powder | | | | | | | | | | |

| total | | 100.0 | 100.0 | 100.0 | 100.0 | 100.0 | 100.0 | 100.0 | 100.0 | 100.0 | 100.0 |
|---|---|---|---|---|---|---|---|---|---|---|---|
| | thermal conductivity | 1.6 | 1.6 | 1.7 | 1.8 | 1.7 | 1.1 | 1.1 | 3.1 | 1.8 | 1.4 |
| | (W/m · K) | | | | | | | | | | |

Furthermore, test pieces for Embodiments 1-14 and Comparative Examples 1-5 were prepared by cutting the friction material of the disc brake pads into specimens having dimensions of 25 mm×15 mm×15 mm.

Table 3 shows the “Testing Conditions,” “Material of Mating Member,” “Evaluation Items,” and “Evaluation Standards” used to evaluate the stability of the braking effect and the wear resistance of the friction material using the prepared test pieces.

TABLE 3

| | | braking effectiveness | wear resistance of the friction material |
|---|---|---|---|
| testing condition | | based on JASO C406 | based on JASO C406 |
| | | friction tester (1/10 scale tester) | friction tester (1/10 scale tester) |
| material of the mating | | martensitic stainless steel | martensitic stainless steel |
| member | | | |
| evaluation Items | | changes relative to μ level of the base | wear amount of friction of the brake |
| | | material x cast iron at JASO-C406 | pad after JASO-C406 friction testing |
| | | friction testing | |
| evaluation | E | 0.38 with tolerance of less than ±5% | less than 1.5 mm |
| Standard | G | 0.38 with tolerance of more than ±5% | 1.5 mm or more but less than 2.0 mm |
| | | but less than ±10% | |
| | P | 0.38 with tolerance of ±10% or more | 2.0 mm or more but less than 2.5 mm |
| | | but less than ±15% | |
| | F | 0.38 with tolerance of ±15% or more | 2.5 mm or more |
| | — | Unable to evaluate because of the product | Unable to evaluate because of the |
| | | wrinkle or crack | product wrinkle or crack |

Table 4 shows the “Evaluation Items” and “Evaluation Standards” for the “Product Appearance” of the test pieces. The term “Product” herein refers to the final product, i.e., the disc brake pad.

TABLE 4

| | | product appearance |
|---|---|---|
| | | visual checking of |
| evaluation items | | the product appearance |
| evaluation | ◯ | no wrinkles and crack |
| standard | X | wrinkles and crack |

Tables 5 and 6 present the results of the evaluations of “Stability of the Braking Effect,” “Wear Resistance of the Friction Material,” and “Product Appearance,” as defined in Tables 3 and 4, with respect to the respective Embodiments and Comparative Examples.

TABLE 5

| | | embodiments | | | | | | | | |
|---|---|---|---|---|---|---|---|---|---|---|
| | | 1 | 2 | 3 | 4 | 5 | 6 | 7 | 8 | 9 |
| evaluation | stability of | P | G | E | G | P | P | E | E | G |
| result | braking | | | | | | | | | |
| | effectiveness | | | | | | | | | |
| | wear resistance | P | G | E | E | E | E | E | E | P |
| | product | G | G | G | G | G | G | G | G | G |
| | appearance | | | | | | | | | |

E = excellent
G = good
P = pass

TABLE 6

| | | embodiments | | | | | comparative examples | | | | |
|---|---|---|---|---|---|---|---|---|---|---|---|
| | | 10 | 11 | 12 | 13 | 14 | 1 | 2 | 3 | 4 | 5 |
| evaluation | stability of | P | G | E | E | E | F | F | F | F | — |
| result | braking | | | | | | | | | | |
| | effectiveness | | | | | | | | | | |
| | wear | E | E | E | G | P | F | P | E | E | — |
| | resistance | | | | | | | | | | |
| | product | G | G | G | G | G | G | G | G | G | F |
| | appearance | | | | | | | | | | |

E = excellent
G = good
P = pass
F = fail
— = unable to evaluate

From the results shown in Tables 5 and 6, it can be confirmed that the friction materials satisfying the conditions of the present invention exhibit satisfactory performance with respect to the stability of the braking effect, the wear resistance of the friction material, and the product appearance.

According to the present invention, in a friction pair consisting of a disc brake pad having a friction material manufactured from a composition containing a binder, a fiber base material, and a friction modifier, while excluding copper components and ferrous-based metallic fibers, together with a stainless steel disc rotor, there is provided a friction pair exhibiting excellent stability of the braking effect, excellent wear resistance of the friction material, and excellent product appearance, thereby ensuring high practical value.

What we claim is:

1. A friction pair being consisting of a disc brake pad having a friction material manufactured from a friction material composition comprising a binder, a fiber base material, and a friction modifier, but not comprising a copper component and a ferrous-base metallic fiber, and a stainless steel disc rotor,
wherein the friction material composition does not contain a metallic fiber other than a ferrous-base metallic fiber but contains 10-15 wt % of a carbonaceous lubricant as a friction modifier relative to an entire friction material composition, and 15-30 wt % of an inorganic friction modifier with Mohs hardness of 6 or more relative to the entire friction material composition, and
a thermal conductivity of the friction material is 1.2-3.0 W/m·K.

2. The friction pair according to claim 1,
wherein the carbonaceous lubricant may be one or more materials selected from the group consisting of an artificial graphite, a natural graphite, a graphite sheet pulverized powder, a petroleum coke, a coal coke, a resilient graphite carbon, and a polyacrylonitrile oxidized fiber pulverized powder.

3. The friction pair according to claim 2,
wherein the carbonaceous lubricant is made of the graphite sheet pulverized powder, the petroleum coke, and the resilient graphite carbon.

4. The friction pair according to claim 1,
wherein 13-28 wt % of a zirconium oxide with an average particle diameter of 0.5-8.0 μm relative to the entire friction material composition is contained as a part of the inorganic friction modifier with Mohs hardness of 6 or more.

5. The friction pair according to claim 2,
wherein 13-28 wt % of a zirconium oxide with an average particle diameter of 0.5-8.0 μm relative to the entire friction material composition is contained as a part of the inorganic friction modifier with Mohs hardness of 6 or more.

6. The friction pair according to claim 3,
wherein 13-28 wt % of a zirconium oxide with an average particle diameter of 0.5-8.0 μm relative to the entire friction material composition is contained as a part of the inorganic friction modifier with Mohs hardness of 6 or more.

7. A friction pair consisting of a stainless steel disc rotor and a disc brake pad having a friction material manufactured from a friction material composition comprising a binder, a fiber base material, and a friction modifier,
wherein the friction material composition is entirely free of copper components so as to prevent galvanic corrosion of the stainless steel rotor and to maintain stability of a protective oxide film and is further free of metallic fibers so as to avoid localized thermal hotspots and to preserve structural strength of the friction material during repeated braking; and
wherein the friction material composition contains 10-15 wt % of a carbonaceous lubricant that provides controlled lubricity, enhances wear resistance, and promotes heat dissipation and further contains 15-30 wt % of an inorganic friction modifier with a Mohs hardness of 6 or greater that produces a grinding action to stabilize the friction coefficient at low vehicle speeds, the friction material as a whole being controlled to a thermal conductivity of 1.2-3.0 W/m·K to suppress excessive temperature rise, inhibit thermal decomposition of the binder, and thereby ensure braking stability and fade resistance.

8. The friction pair according to claim 7,
wherein the carbonaceous lubricant comprises a graphite sheet pulverized powder, a petroleum coke, and a resilient graphite carbon, so as to enhance heat dissipation at the friction surface and further improve wear resistance of the friction material.

9. The friction pair according to claim 7,
wherein 13-28 wt % of zirconium oxide having an average particle diameter of 0.5-8.0 μm is included as part of the inorganic friction modifier, thereby forming a uniform interfacial layer with the stainless steel rotor and stabilizing braking torque while suppressing uneven rotor wear.

10. The friction pair according to claim 7,
wherein the thermal conductivity of the friction material is maintained within 1.5-2.8 W/m·K, so as to achieve an optimal balance between heat dissipation and braking stability, thereby minimizing thermal fade during repeated braking.

11. The friction pair according to claim 7,
wherein the friction material composition further contains 3-8 wt % of an organic friction modifier relative to the entire composition, so as to stabilize noise and vibration performance (NV performance) without causing instability of the braking coefficient.

12. The friction pair according to claim 7,
wherein the friction material composition further contains 6-8 wt % of a binder relative to the entire composition, so as to simultaneously provide sufficient thermal stability and mechanical strength of the friction material.

13. The friction pair according to claim 7,
wherein the friction material composition further contains 2-4 wt % of a fiber base material relative to the entire composition, so as to provide reinforcement of the friction material while avoiding mixing defect.

14. The friction pair according to claim 7,
wherein the disc brake pad is manufactured by a process including a coating step followed by a baking step and thereafter a grinding step, so as to improve and stabilize the product appearance of the disc brake pad.

15. The friction pair according to claim 7,
wherein the disc brake pad is manufactured by a process further including, prior to heat press forming, at least one of a granulating step, a kneading step, or a pre-forming step, so as to improve uniformity of the raw friction material mixture and thereby enhance consistency of product quality.

16. The friction pair according to claim 7,
wherein the disc brake pad is manufactured by a process further including a scorching step after heat press forming, so as to improve curing stability and enhance long-term durability of the friction material.

17. A friction pair consisting of a stainless steel disc rotor and a disc brake pad having a friction material manufactured from a friction material composition comprising a binder, a fiber base material, and a friction modifier,
wherein the friction material composition is entirely free of copper components and metallic fibers including ferrous-base metallic fibers, so as to prevent galvanic corrosion of the stainless steel rotor and to suppress localized thermal hotspots; and
wherein the friction material composition contains 10-15 wt % of a carbonaceous lubricant including a graphite sheet pulverized powder, a petroleum coke, and a resilient graphite carbon, and further contains 15-30 wt % of an inorganic friction modifier including 13-28 wt % of zirconium oxide having an average particle diameter of 0.5-8 μm, the friction material being controlled to a thermal conductivity of 1.5-2.8 W/m·K, so as to provide stable braking torque at low speeds, inhibit thermal decomposition of the binder, and ensure braking stability, wear resistance, and fade resistance.
